(19) United States
(12) Patent Application Publication
(10) Pub. No.: US 2007/0239580 A1
(43) Pub. Date: Oct. 11, 2007

(54) Methods and systems for providing equity volatility estimates and forecasts

(76) Inventor: Peter L. Ciampi, Lexington, MA (US)

Correspondence Address: MORGAN LEWIS & BOCKIUS LLP, 1111 PENNSYLVANIA AVENUE NW, WASHINGTON, DC, 20004, US

(21) Appl. No.: 11/786,252

(22) Filed: Apr. 10, 2007

Related U.S. Application Data
(60) Provisional application No. 60/791,177, filed on Apr. 10, 2006.

(51) Int. Cl. G06Q 40/00

(52) U.S. Cl. 705/35

(57) ABSTRACT

In one aspect, the present invention comprises a method comprising the following steps: receiving high frequency trading and pricing data for a security; estimating current volatility of price of the security based on the high frequency trading and pricing data; forecasting future volatility of the price using two or more volatility forecasting models; back-testing each of the two or more models out-of-sample; ranking the two or more models in terms of reliability of each of the models, over a recent period of time, for the security; and reporting volatility forecasts of each of the models to a user, along with each model's reliability ranking.

### CROSS REFERENCE TO RELATED APPLICATIONS

This application claims priority to U.S. Provisional Patent Application No. 60/791,177, filed Apr. 10, 2006. The entire contents of that provisional application are incorporated herein by reference.

### BACKGROUND AND SUMMARY

Equity volatility estimates play an important role in finance. In their landmark 1973 paper, Black and Scholes derived a formula for pricing a vanilla put or call option on a non-dividend paying stock (“underlyer”). That formula requires as inputs the underlyer's current price, the option's strike price, the option's time to expiration, a risk free interest rate, and the underlyer's annual volatility (based on log returns).

All of these quantities are (typically) observable in the marketplace—except the volatility. Accordingly, financial engineering has spawned a tremendous need to estimate volatilities.

One way to estimate volatility for a given underlyer is to use the price of an option on that underlyer. Suppose a call option on the underlyer is actively traded, so the option's price is readily obtainable. Then, by applying a suitable option pricing formula one can calculate the annual volatility that would have to be input into the Black-Scholes option pricing formula to obtain that price for the option. In this manner, one obtains the volatility implied by the option price—what is called the implied volatility for the underlyer.

Another approach to estimating volatilities is to consider historical data for the underlyer whose volatility is to be estimated. Volatilities calculated in this manner are called historical volatilities. Historical volatilities are routinely used in applications (such as value-at-risk or portfolio theory) where volatilities are required for quantities on which options are not traded. Financial analysts also might use historical volatilities as a reality check to supplement implied volatility estimates.

A question that frequently arises is whether implied or historical volatilities offer a better indication of market risk. The answer is that each has its strengths as well as limitations. Implied volatilities are often referred to as a “market consensus” of volatility—an indication of risk that combines the insights of many market participants. For the most part, this is a reasonable interpretation. However, implied volatilities are essentially prices. They can be biased by such things as bid-ask spreads as well as supply and demand for options.

Historical volatility, on the other hand, reflects actual market fluctuations. However, the data upon which an historical volatility is based may be stale—perhaps encompassing a period not reflective of current market conditions. For this reason, implied volatilities tend to be more responsive to current market conditions.

Using high-frequency intra-day trades, rather than daily closing prices, provides a much more accurate measure of historical volatility. This idea hasn't been implemented until recently because of “market-micro-structure” noise problems such as “bid-ask bounce.” “Realized-volatility for the Whole Day” by Hansen and Lunde (cited below) provides solutions to such noise problems—i.e., it makes use of high-frequency data practical.

Bond Pricing

A call option gives the buyer of the option the right (but not the obligation) to buy a fixed number of shares of a stock at a fixed price (“strike price”) at a specified time in the future. A put option gives the buyer the right (but not the obligation) to sell a fixed number of shares of a stock at a fixed price at a specified time in the future.

Viewing a corporation simply as shareholders' equity and debt: if the corporation is dissolved and is worth more than its debt, the debt holder (i.e., bond holders) just receives the value of the debt. On the other hand, if the corporation is worth less than the debt, the debt holder only gets the value of the company back. This is like getting all the debt back but paying back to the shareholders the difference between the company and the value of the original debt. In other words, the holder of the debt has sold a put option with a strike equal to the debt amount as well as being guaranteed to receive the value of the debt.

Levered equity is also a put option. The shareholders own the assets of the firm, but they also have a liability equal to the interest and principal on the debt. The shareholders also own a put option, sold by the bond holders, with a strike price equal to the interest and principal of the bond. If, at the maturity of the debt, the assets of the firm are less in value than the debt, shareholders have an in-the-money put. They will put the firm to the bond holders and cancel the debt. If, at the maturity of the debt, the shareholders have an out-of-the-money put, they will not exercise the option (i.e., not declare bankruptcy) and let the put expire.

This is an example of the put-call parity relationship: Price of call=Price of underlying asset+Price of put−Present value of the exercise price

The price of the underlying asset in this case is the value of the firm. The exercise price is the principal and interest due on the risky debt. The present value of this at a riskless rate is the value of a default-free bond. Finally, if the value of the firm exceeds the exercise price, the value of the call option equals the difference between the value of the firm and the exercise price. Otherwise, the value of the call option is zero. Thus, the value of the firm minus the value of the call option equals the minimum of the exercise price and the value of the firm, that is, it equals the value of the risky debt.

Putting these conclusions together we get, Value of call on firm=Value of firm+Value of put on firm−Value of default-free bond. Rearranging, we get Value of risky bond=Value of default-free bond−Value of put on firm. The reduced value of the debt will be reflected in its higher rate of return. The discount for the possibility of default can be calculated as the value of the put option.

One of the most popular credit derivatives is a credit default swap (CDS). This contract provides insurance against a default by a particular company or sovereign entity. The company is known as the reference entity and a default by the company is known as a credit event. The buyer of the insurance makes periodic payments to the seller and in return obtains the right to sell a bond issued by the reference entity for its face value if a credit event occurs. The rate of payments made per year by the buyer is known as the CDS spread.

Credit ratings for sovereign and corporate bond issues have been produced in the United States by rating agencies such as Moody's and Standard and Poor's (S&P) for many years. In the case of Moody's the best rating is Aaa. Bonds with this rating are considered to have almost no chance of defaulting in the near future. The next best rating is Aa. After that come A, Baa, Ba, B and Caa. The S&P ratings corresponding to Moody's Aaa, Aa, A, Baa, Ba, B, and Caa are AAA, AA, A, BBB, BB, B, and CCC respectively. To create finer rating categories Moody's divides its Aa category into Aa1, Aa2, and Aa3; it divides A into A1, A2, and A3; and so on. Similarly S&P divides its AA category into AA+, AA, and AA−; it divides its A category into A+, A, and A−, etc. Only the Moody's Aaa and S&P AAA categories are not subdivided. Ratings below Baa3 (Moody's) and BBB−(S&P) are referred to as “below investment grade.”

Analysts and commentators often use ratings as descriptors of the creditworthiness of bond issuers rather than descriptors of the quality of the bonds themselves. This is reasonable because it is rare for two different bonds issued by the same company to have different ratings. Indeed, when rating agencies announce rating changes they often refer to companies, not individual bond issues.

In theory the N-year CDS spread should be close to the excess of the yield on an N-year bond issued by the reference entity over the risk-free rate. This is because a portfolio consisting of a CDS and a par yield bond issued by the reference entity is very similar to a par yield risk-free bond. Some researchers have found that the credit default swap market leads the bond market—i.e., most price discovery occurs in the credit default swap market—and that the credit default swap market appears to use the swap rate rather than the Treasury rate as the risk-free rate. Others have considered the relationship between credit default swap spreads and credit ratings.

However, recent research has shown that volatility can explain bond spreads (i.e., prices) even more than credit rating. Campbell (cited below) has asserted that daily volatility alone can explain 37% of spreads (credit rating alone explain 33% of spreads, and combined they explain 41% of spreads). Moreover, an unpublished paper by Zhang, Zhou, and Zhu (included herewith) finds that high frequency volatility plus daily volatility plus credit rating explains 77% of CDS spreads. In other words, market data alone may be used to explain much of the “explainable” spread.

Volatility is a leading indicator for Credit Spread Change. See FIG. 2 (Plot of GM RV versus Credit downgrades).

As discussed above, in addition to estimating volatility from equity trades (historical volatility) one can estimate volatility from option prices (implied volatility). For years the Black-Scholes-Merton formula has been used to estimate implied volatility, but recent work has shown that a model-free implied volatility is better. Indeed, the Chicago Board Options Exchange (CBOE) switched to this method in 2003. See the enclosed paper “VIX: CBOE Volatility Index.” The VIX model-free formula estimates volatility “by averaging the weighted prices of out-of-the-money puts and calls.”

Also, volatility often proxies for risk in modern finance (Anderson et al. (2005, cited below). This is relevant to (1) portfolio allocation e.g., computing mean-variance frontiers; (2) derivatives and CDS valuation; and (3) risk management (e.g., value-at-risk, Sharpe ratio).

Thus, volatility is central to modern finance and has many applications, such as risk management, pricing derivatives, and as a complement to credit rating.

In one aspect, the present invention comprises a method comprising the following steps: receiving high frequency trading and pricing data for a security; estimating current volatility of price of the security based on the high frequency trading and pricing data; forecasting future volatility of the price using two or more volatility forecasting models; back-testing each of the two or more models out-of-sample; ranking the two or more models in terms of reliability of each of the models, over a recent period of time, for the security; and reporting volatility forecasts of each of the models to a user, along with each model's reliability ranking.

In various embodiments: (1) the method further comprises reporting a current volatility estimate for the security; (2) current volatility is estimated using historical volatility estimation; (3) current volatility is estimated using implied volatility estimation; (4) bid-ask bounce, missing trades, and overnight closes are taken into account when estimating current volatility of price of the security based on the high frequency trading and pricing data; (5) the two or more volatility forecasting models comprise at least three of the following: (a) random walk; (b) autoregression with optimized lag length; (c) exponential smoothing; and (d) GARCH (1, 1); and (6) the two or more volatility forecasting models comprise the following: (a) random walk; (b) autoregression with optimized lag length; (c) exponential smoothing; and (d) GARCH (1,1).

### BRIEF DESCRIPTION OF THE DRAWINGS

FIG. 1 is a plot of actual vs. forecast volatility.

FIG. 2 is a plot of GM RV versus Credit downgrades.

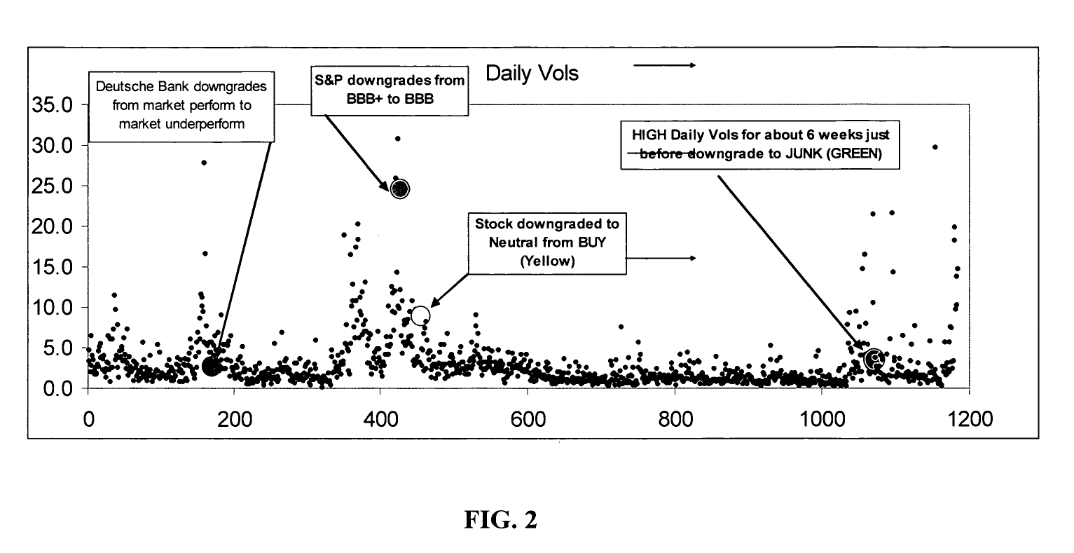

### DETAILED DESCRIPTION OF PREFERRED EMBODIMENTS

Estimation of Volatility

Volatility, since it is not an observable, must be estimated. As discussed above, there are two main approaches to volatility estimates: historical volatility (also referred to herein as realized volatility, or RV) and implied volatility (IV). But within each of these two main approaches there are many specific approaches.

At least one preferred embodiment of the invention comprises the following steps: (1) receive high frequency trade data; (2) estimate volatility based on that data (using historical and/or implied volatility estimation techniques); (3) use a plurality of volatility forecasting models to forecast volatility; (3) back-test each of those models (out of sample) to rank the forecasting models in terms of reliability; and (4) report the volatility forecasts resulting from each model to a user, along with each model's reliability ranking. In at least one embodiment, the volatility estimate(s) also are reported.

The high frequency trade data preferably is processed according to the methods taught by Hansen and Lunde, so as to deal with bid/ask bounce and other microstructure noise problems.

High-Frequency Data (Realized Volatility, or “RV”)

If one could observe prices continuously, volatility would be observed (no need to estimate). But that data is unavailable. The next best data is high frequency trade data. But until recently using high-frequency prices has been problematic, due to the bid-ask bounce, missing trades, and overnight closes. However, the above-mentioned recent work by Hansen and Lunde shows how to manage these issues (along with outliers).

“Model-free” Implied Volatility

The Black-Scholes-Merton formula uses volatility to calculate option prices so one can reverse the process: observe option prices; then calculate volatility. Two problems with this technique are that (a) it assumes the BSM model is the true model of the world; and (b) it assumes that prices make no jumps. Model-free implied volatility avoids these problems. (See the paper by Jiang and Tian, referenced below.)

High Frequency trade data preferably is processed using a technique that accounts for: obtaining and managing volumes of intra-day ticks; managing outliers and bid-ask bounce, autocorrelation of trades; closed periods: (4 pm-9:30 am, weekends); and non-synchronous trades.

In a preferred embodiment, four volatility forecasting methods are used:

1) Random Walk, as a baseline (the volatility estimate itself is the forecast);

2) AutoRegresssion with optimized lag length;

3) Exponential Smoothing, commonly used with a decay rate of 0.06; and

4) GARCH (1,1).

In more detail:

1) Random Walk—uses today's value as the forecast for the future value. It's essentially a benchmark to which the other models are compared.

2) Autoregression with optimized lags. Autoregression is a linear regression technique wherein the explanatory variables are past values of the variable being estimated. Each time we create a forecast we decide how many lagged variables to use. A reference is pages 156-165 of “Elements of Forecasting” by Francis X. Diebold, South-Western College Publishing, 1998.

3) GARCH. The reference here is pages 387 through 391 of Diebold's book. The model is today's variance=a1+a2 * today's shock (that is a contribution to unconditional variance)+a3 * (variance as of yesterday).

4) Exponential Smoothing. This is a GARCH model (see model #3) but instead of estimating the parameters (a1, a2, and a3) with past data every period, we use fixed values. For example, we selected values of a1=0, a2=0.06 and a3=0.94 in our testing.

Experimentation has shown that various methods have proven more reliable than others for various securities, but that no one method is more reliable for all securities. Thus, a preferred embodiment uses several different methods for a given security, then tells the user which methods performed better for that security.

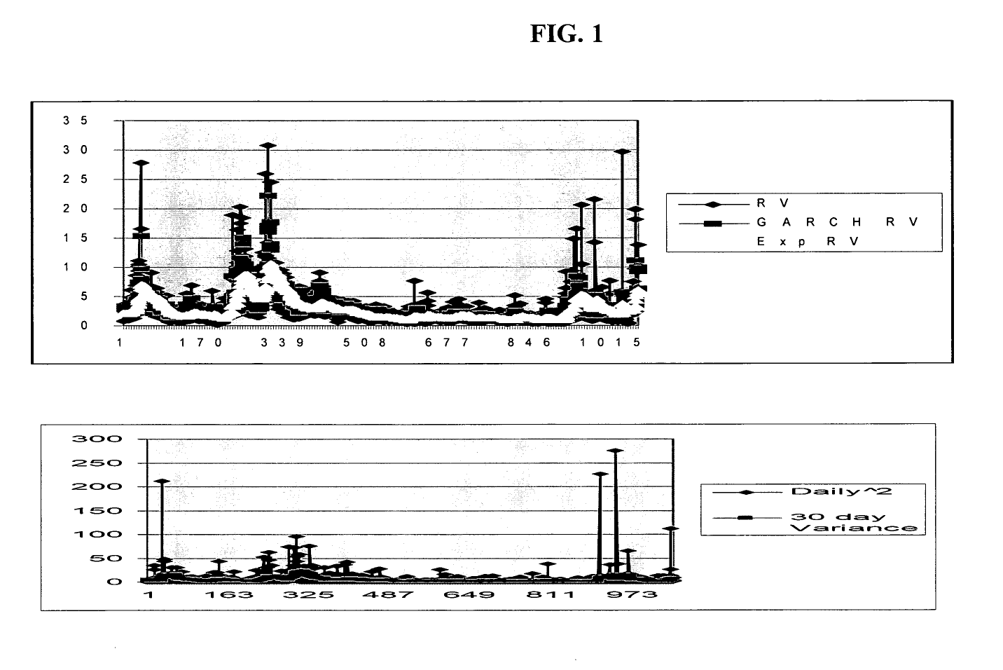

FIG. 1 is a plot of actual vs. forecast volatility. Volatility estimates are jagged; volatility forecasts are close but smooth.

Thus, one preferred embodiment uses 3 volatility estimates, 4 forecasting methods, and 3 future volatility estimates for measuring forecast performance. Of course, those skilled in the art will recognize that any number of volatility estimates and forecasting methods may be used without departing from the scope of the present invention.

Note that Implied Volatility (“IV”) is itself a forecast—an expectation of volatility—so estimating and forecasting doesn't apply to IV. So the possibilities for the above embodiment reduce to inputting equity estimates (RV and daily) into the forecasting methods.

But there is support for the assertion that realized volatility is the best input.

Example: Time Window: Aug. 1, 2003 till Aug. 1, 2005, 750 days. 125 days for GARCH and Exponential Weighting, so 625 days of forecasts. Securities: Aetna, Alcoa Aluminum, Anheuser Busch, General Motors, Loews, Motorola, RiteAid, JC Penny, General Electric, IBM. Table 1 shows the percent reduction in mean square error of the three forecasting methods over a baseline that assumes tomorrow's value will be today's value.

TABLE 1
Percent MSE reduction over a Random Walk by forecasting
tomorrow's RV by inputting previous values of
RV into three forecasting methods

| | | Exponential | |
|---|---|---|---|
| | Garch: | Weighting | AutoRegression |
| Aetna | 40% | 39% | 43% |
| Alcoa | 25% | 24% | 25% |
| Anheuser Busch | 45% | 46% | 46% |
| GM | 24% | 30% | 32% |
| Loews | 24% | 26% | 28% |
| Motorola | 36% | 37% | 40% |
| Rite Aid | 44% | 45% | 46% |
| JC Penny | 17% | 18% | 24% |
| GE | −2% | 36% | 38% |
| IBM | 7% | 30% | 34% |

Observations: For these 10 securities over a 3 year period, the forecasting methods clearly outperform a random walk, which assumes that the best forecast for tomorrow is today's value. The methods appear similar with Auto Regression with variable lag slightly outperforming the others. Specifically, in every case it equaled of outperformed the others.

What about 30 day volatility forecasts? A first question is why estimate 30-day volatility if Realized Volatility is true? It depends on the application. Certainly for trading one would estimate realized volatility, but for daily mark-to-market or for a certain 30 day holding, one might be interested in 30 day volatility. Table 2 below shows that even in this case RV is a better input than daily historical volatility in predicting 30 day volatility.

TABLE 2
Percent improvement from using 30 day
volatility over using RV as input

| | |
|---|---|
| Aetna | 6% |
| Alcoa | 6% |
| Anheuser Busch | 8% |
| GM | −6% |
| Loews | 11% |
| Motorola | 7% |
| Rite Aid | 6% |
| JC Penny | 11% |
| GE | −11% |
| IBM | 20% |

### REFERENCES

Andersen, T. G., Bollerslev, T., Christoffersen, P. F. and Diebold, F. X. (2005), “Practical Volatility and Correlation Modeling for Financial Market Risk Management,” in M. Carey and R. Stulz (eds.), Risks of Financial Institutions, University of Chicago Press for NBER, forthcoming.

Black, Fischer and Myron S. Scholes (1973), “The pricing of options and corporate liabilities,” Journal of Political Economy, 81, 637-654.

Bollerslev, Tim, Gibson, Michael S. and Zhou, Hao, “Dynamic Estimation of Volatility Risk Premia and Investor Risk Aversion from Option-Implied and Realized Volatilities” (April 2006). FEDS Working Paper No. 2004-56 Available at SSRN: http://ssrn.com/abstract=614543.

Campbell, J. Y. and Taksler, G. B., “Equity Volatility and Corporate Bond Yields,” Journal of Finance, vol. 58(6), pages 2321-2350, December 2003.

French, K. R., Schwert, G. W., and Stambaugh, R. F., “Expected Stock Returns and Volatility,” Journal of Financial Economics, pages 3-29, vol. 19 (September 1987).

Hansen, Peter Reinhard and Lunde, Asger, “A Realized Variance for the Whole Day Based on Intermittent High-Frequency Data,” Journal of Financial Econometrics, pages 525-554, vol. 3 (April 2005).

Jiang, George and Yisong Tian, “The Model-Free Implied Volatility and Its Information Content,” The Review of Financial Studies, pages 1305-1342, vol. 18 (April 2005).

Merton, Robert C. “On the Pricing of Corporate Debt: The Risk Structure of Interest Rates,” Journal of Finance, pages 449-470, vol. 29, (1974).

The entire contents of each of the papers referenced herein and/or included herewith are incorporated into this patent application by reference for all purposes.

It will be appreciated that the present invention has been described by way of example only, and that improvements and modifications may be made to the invention without departing from the scope or spirit thereof.

I claim:

1. A method comprising:
receiving high frequency trading and pricing data for a security;
estimating current volatility of price of said security based on said high frequency trading and pricing data;
forecasting future volatility of said price using two or more volatility forecasting models;
back-testing each of said two or more models out-of-sample;
ranking said two or more models in terms of reliability of each of said models, over a recent period of time, for said security; and
reporting volatility forecasts of each of said models to a user, along with each model's reliability ranking.

2. A method as in claim 1, further comprising reporting a current volatility estimate for said security.

3. A method as in claim 1, wherein current volatility is estimated using historical volatility estimation.

4. A method as in claim 1, wherein current volatility is estimated using implied volatility estimation.

5. A method as in claim 1, wherein bid-ask bounce, missing trades, and overnight closes are taken into account when estimating current volatility of price of said security based on said high frequency trading and pricing data.

6. A method as in claim 1, wherein said two or more volatility forecasting models comprise at least three of the following: (a) random walk; (b) autoregression with optimized lag length; (c) exponential smoothing; and (d) GARCH (1, 1).

7. A method as in claim 1, wherein said two or more volatility forecasting models comprise the following: (a) random walk; (b) autoregression with optimized lag length; (c) exponential smoothing; and (d) GARCH (1,1).
